(19) United States
(12) Patent Application Publication
(10) Pub. No.: US 2007/0131242 A1
(43) Pub. Date: Jun. 14, 2007

(54) FLOSSING DEVICE

(76) Inventor: Gerald W. Fleck, Carlsbad, CA (US)

Correspondence Address: FRANK G MORKUNAS, 7750 DAGGET ST, SUITE 203, SAN DIEGO, CA, 92111, US

(21) Appl. No.: 11/608,485

(22) Filed: Dec. 8, 2006

Related U.S. Application Data
(60) Provisional application No. 60/748,765, filed on Dec. 9, 2005.

(51) Int. Cl. A61C 15/00

(52) U.S. Cl. 132/321

(57) ABSTRACT

A radially-shaped flossing device having a flexible tubular section with an internal channel through which a loop of floss passes. The length of floss is greater than the length of tubular section which defines a gap where the gap distance exposes floss to be used by a user to floss teeth. After flossing, a user may pull the floss in a designated direction to expose previously unexposed and un-used floss for later use. The flossing device may have more than one tubular section which combined length is shorter than the length of the loop of floss defining a gap for flossing use. After flossing, one tubular section adjacent to the gap is moved to the next tubular section adjacent to the gap to expose a fresh floss portion for later use.

### CROSS REFERENCES TO RELATED APPLICATIONS

This application claims the benefit of U.S. Provisional Application No. 60/748,765 filed on Dec. 9, 2005.

### STATEMENT REGARDING FEDERALLY-SPONSORED RESEARCH OR DEVELOPMENT

Not applicable.

### BACKGROUND

The device of this disclosure relates to an improvement in a dental flossing device, and more particularly to dental flossing devices suited for multiple uses.

Flossing is an important function for good oral hygiene and is accomplished by using dental floss [generally a waxed or unwaxed piece of nylon string] that is inserted between one tooth and another abutting tooth. The floss is then moved in an up/down fashion for the removal of plaque or other food deposits. It is generally agreed by most dentists and oral hygienists that flossing is essential care for the preservation and maintenance of healthy teeth and gums. In spite of this consensus, many if not most people do not floss regularly. This is so because, using floss alone is cumbersome and difficult. Many prior art devices have been crafted in attempts to make flossing easier and, consequently, more regularly performed by more and more people. None have succeeded in this noble cause.

The flossing device of this disclosure is easier and more convenient to use than any of the prior devices. It is comfortable to hold, comfortable to use, and capable of multiple uses. It is relatively easy to manufacture and less costly in materials and time thereby translating to lower costs for the user. As a result, it should encourage persons to floss more regularly.

The foregoing has outlined some of the more pertinent objects of the flossing device of this disclosure. These objects should be construed to be merely illustrative of some of the more prominent features and applications of the flossing device of this disclosure. Many other beneficial results can be attained by applying the disclosed flossing device of this disclosure in a different manner or by modifying the flossing device of this disclosure within the scope of the disclosure. Accordingly, other objects and a fuller understanding of the flossing device of this disclosure may be had by referring to the summary of the flossing device of this disclosure and the detailed description of the preferred embodiment in addition to the scope of the flossing device of this disclosure defined by the claims taken in conjunction with the accompanying drawings.

### SUMMARY

The above-noted problems, among others, are overcome by the flossing device of this disclosure. Briefly stated, the flossing device of this disclosure contemplates a hand-held device that a person may use to floss their teeth. It includes an outer housing (tubular section) that has an internal lumen (channel) which contains a loop of dental floss. The housing is preferably in a semi-annular configuration that curves along a predetermined radius of curvature as determined by the length of the housing and the greater relative length of the floss.

A portion of the dental floss is exposed and the exposed portion can be used to floss a user's teeth. The housing generally is of a soft flexible material which provides a convenient means for the user to grab and manipulate the dental floss without having to actually grab the floss itself and to slide the used portion of the floss in one direction into the housing to thereby slide and expose an unused portion for use as desired.

The foregoing has outlined the more pertinent and important features of the flossing device of this disclosure in order that the detailed description that follows may be better understood so the present contributions to the art may be more fully appreciated. Additional features of the flossing device of this disclosure will be described hereinafter which form the subject of the claims. It should be appreciated by those skilled in the art that the conception and the disclosed specific embodiment may be readily utilized as a basis for modifying or designing other structures and methods for carrying out the same purposes of the flossing device of this disclosure. It also should be realized by those skilled in the art that such equivalent constructions and methods do not depart from the spirit and scope of the flossing device of this disclosure as set forth in the appended claims.

### BRIEF DESCRIPTION OF THE DRAWINGS

For a fuller understanding of the nature and objects of the flossing device of this disclosure, reference should be had to the following detailed description taken in conjunction with the accompanying drawings in which:

FIG. 1 is preferred embodiment of the flossing device.

FIG. 2 is a second embodiment of the flossing device.

### DETAILED DESCRIPTION

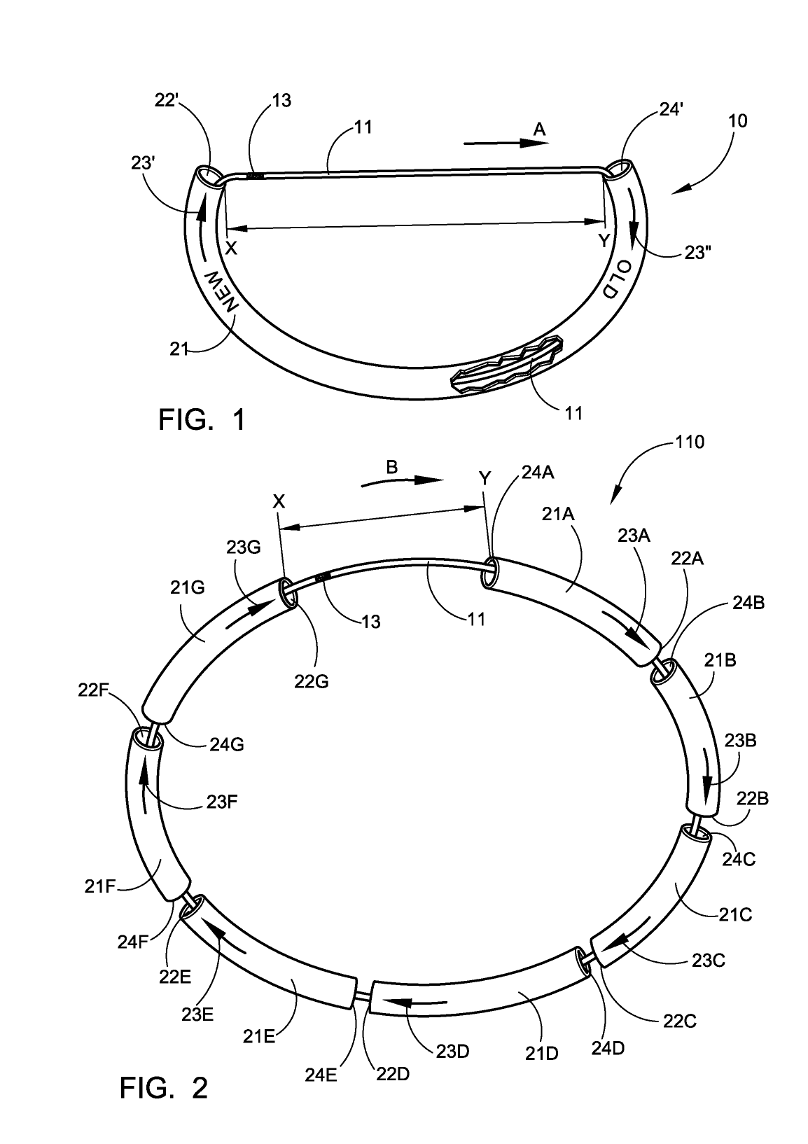

Referring now to the drawings in detail and in particular to FIG. 1, reference character 10 generally designates a flossing device constructed in accordance with a preferred embodiment of the flossing device of this disclosure. This flossing device 10 combines the use of a looped section of dental floss 11 with a tubular section 21 which covers the floss 11 and has a channel from one end of the tubular section 21 to the other end through which the floss passes. The tubular section 21 should generally be of a relatively flexible material so as to provide a soft, flexible, and comfortable method to hold, grip, and advance the floss 11 as the flossing device 10 is used.

Typical tubular materials suited for the intended purpose include, but are not limited to, latex [synthetic or natural], silicone, Teflon® and other polymers, vinyl, other plastics, or any combinations thereof.

The loop of dental floss 11 passes through the channel of tubular section 21 from one end 22′ to the other end 24′. The length of the floss 11 is greater than the length of the tubular section 21 but not so great as to cause the tubular section 21 to be linear or only slightly curvilinear. The length of the floss 11 is such that, when the device 10 is manufactured and the floss 11 placed into the channel of the tubular section 21 and looped, the tubular section 21 becomes somewhat U-shaped as illustrated in FIG. 1.

A gap is created between one end 22′ of the tubular section 21 and the other end 24′ thereby exposing a portion of the floss 11. This gap is represented by reference characters X-Y. The length of this gap may be sized to be approximately one to two index finger lengths of the intended user [approximately 2-20 cm]. The length of the floss loop 11 is set to provide sufficient floss to perform at least one complete flossing of a set of teeth.

In use, the user would grip and/or pinch the tubular section 21 at or near both ends 22′, 24′. This gripping and/or pinching along with a radial force pulling apart one end 22′ of the tubular section 21 and the other end 24′ creates tension in the floss 11 as it is guided in place with other available fingers or thumbs. As so held in place by a user the exposed portion of floss 11 in the gap is then slid between and down along the sides of teeth to be flossed.

This sizing of the gap in relation to the floss 11 length creates the desired U-shape and gap necessary for the best operation of the device 10. Additional sizing for good operation of the device 10 has the length of the looped floss 11 to be approximately 10% to 80% greater than the length of the tubular section 21 thereby making the gap distance approximately 10% to 80% of the length of the tubular section 21.

After the user is finished flossing with the exposed portion of dental floss 11, the user can slide the dental floss 11 through the curved tubular section 21, generally in the direction of Arrow A [or in an opposite direction as direction here is for illustrative purposes only], such that a new portion of the dental floss 11 becomes exposed and the used portion is slid into the tubular section 21. The tubular section 21, the channel in particular, is preferably manufactured with a texture and/or of a lubricous material that facilitates sliding of the dental floss 11 through the tubular section 21. Typical lubricous materials include, but are not limited to, wax, nylon, vinyl, or Teflon® coating.

To aid a user in exposing an unused portion of floss 11 rather than a previously used portion of floss, directional indicia 23′, 23″ on either end, or on both ends 22′, 24′ of the tubular section 21 inform the user of which direction the floss 11 should be slid. Directional indicia here are arrow but words such as “used” and “un-used” or “old” and “new” or color-coding such as “red” for used and “green” for un-used and the like may be used as said directional indicia.

A fresh unused portion of the floss 11 can be exposed by advancing the loop of floss 11 through the tubular section 21. To accomplish this one can pinch the floss 11 directly between the thumb and one of the fingers on one hand while holding the tubular section 21 loosely in the other hand. The hand holding the device 10 can also be used to slightly squeeze the opposite ends 22′, 24′ of the tubular section 21 towards each other to relieve tension on the floss 11 caused by the tubing. Then by gently pulling on the floss 11 it can be moved so that the used portion goes into the tube on one side while fresh unused floss 11 is exposed as it is pulled out of the other side of the tubular section 21.

Another method to advance the floss 11 is to stretch the tubular section 21 along its length and then pinch and hold the floss 11 within the tubular section 21. To start with the device 10 being held in a relaxed state (no external deforming forces applied), the left thumb and finger pinch down on the tubular section 21 to hold the floss 11 in place while the right hand pulls on the right side of the tubular section 21 stretching it while allowing the floss 11 to slide within it. Then the right hand thumb and finger pinch down on the tubular section 21 to hold the floss 11 in place while the left hand releases its grip returning the device 10 to its relaxed state.

Additionally, since the floss 11 is in a loop, a registration indicia 13 on the floss 11 alerts the user to a start and stop point. In this regard, the registration indicia 13 may be positioned at or near one end, 24′ for example, of the tubular section 21 by sliding the floss 11 accordingly. As the device 10 is used and the floss 11 is slid to expose unused floss 11, the registration indicia 13 will disappear into the end 24′ and, after repeated uses, emerge from the end 22′. Ultimately the registration indicia 13 will return to the point from which it began. This alerts the user that all the floss 11 has been used and it may be time for a replacement device.

The registration indicia 13 may be a color-coded section, a knot or bulge in the floss 11, or any other similarly noticeable and easily detectable means. There may also be more than one such indicia with the spacing between each indicia being set to approximately equal to the length of the gap distance X-Y or shorter so that the user may track how far the floss 11 is being advanced.

In addition, the tubular section 21 preferably has a radius of curvature that facilitates sliding of the dental floss 11 through the tubular section 21.

As mentioned above, the two principal components to this device 10, and its implementation, are the dental floss loop 11 and the tubular section 21. The device 10 can be held to position the exposed floss 11 to floss and clean teeth. Two fingers and or thumbs or any combination thereof are used to guide the exposed floss 11 to position it between and along the sides of teeth for the flossing action. One finger or thumb positions the floss 11 from the inside of the mouth and the other finger or thumb positions the floss 11 from the outside of the month from opposite sides of a tooth.

The remaining fingers on each hand can be used to apply tension to the exposed floss 11 by gripping the tubular section 21 near the exposed floss ends and pulling in opposing directions. Depending on the length of the floss loop 11 relative to the user's hand size, tension can also be applied to the loop by pulling radially out on the tubular section 21.

The dimensions of the device 10 can be sized to fit the end user's dimensions as well as to set the amount of floss 11 to be provided. The length of the exposed floss 11 section and the length of the tubular section 21 can be sized to fit the user's hand and mouth size. Small hands and mouths can use a shorter exposed floss 11 section as well as a shorter tubular section 21 than those sized for larger hands and mouths.

The device 10 also can be sized for a single use or extended use by setting the length of the floss loop 11 and the required tubular section 21 while holding fixed the length of the exposed floss section. A single use device would provide the required length of floss in the loop to floss the entire set of teeth for the mouth size it was designed. Multiple use devices will have longer floss loops 11 and a longer corresponding tubular section 21 and may have a larger gap section or in the alternative, may keep the length of the exposed floss section, X-Y, the same as used for a single use device 10 described above.

For long extended use devices a segmented device 110 having multiple tubular sections 21A-G, as shown in FIG. 2, can be used. Segmentation of the device 110 can be used to improve handling very long floss loops. The housing in this embodiment is not a continuous single-piece tubular section 21, but is rather formed from a series of discrete tubular sections 21A-G that each cover a portion of the loop of dental floss 11. Each section has a front or leading end 22A-G and a back or trailing end 24A-G.

Regardless of how many such tubular sections there are [here there are seven shown], generally the gap X-Y should be approximately of equal length as each tubular section 21A-G but may also be shorter or longer. Consequently then, the length of the floss 11 may be equal to the sum of all tubular sections plus one additional tubular section length, or the length of the floss 11 may be equal to the sum of all tubular sections plus the length of the gap X-Y of the floss device 10 as previously described; i.e., 2-20 cm. As shown in this Figure, there are seven such sections. This Figure, however, is not meant as a means of limitation but is only provided for illustration purposes. There may be more or less as desired.

Exposing an unused portion of floss 11 in this embodiment may entail sliding the floss 11 as described above but is best accomplished by sliding one tubular section over the used portion of floss 11 thereby exposing an unused portion of floss 11 in its wake. As in the first embodiment, the floss 11 has a registration indicia 13. A user should find the registration indicia 13 and expose it in the gap X-Y. Referring to FIG. 2, after use, the user would slide tubular section 21G in the direction of Arrow B until its leading end 22G generally abuts or is adjacent to the trailing end 24A of tubular section 21A.

Directional indicia 23A-G on each tubular section 21A-G informs the user into which direction a particular section should be slid.

The tubular sections 21A-G could also initially be connected end-to-end forming one continuous tubular section with perforated seams that could be pulled apart to expose the next portion of the floss loop 11.

The present disclosure includes that contained in the present claims as well as that of the foregoing description. Although this flossing device of this disclosure has been described in its preferred forms with a certain degree of particularity, it is understood that the present disclosure of the preferred forms has been made only by way of example and numerous changes in the details of construction and combination and arrangement of parts and method steps may be resorted to without departing from the spirit and scope of the flossing device of this disclosure. Accordingly, the scope of the flossing device of this disclosure should be determined not by the embodiments illustrated, but by the appended claims and their legal equivalents.

Applicant has attempted to disclose all the embodiments of the flossing device of this disclosure that could be reasonably foreseen. It must be understood, however, that there may be unforeseeable insubstantial modifications to flossing device of this disclosure that remain as equivalents and thereby falling within the scope of the flossing device of this disclosure.

What is claimed is:

1. A flossing device comprising:
(a) a tubular section having a first end and a second end defining a tubular distance therebetween, and further having an internal channel between said first end and said second end; and
(b) a loop of dental floss within said internal channel having a length greater than said tubular distance wherein a portion of said loop is exposed from said tubular section thereby defining a gap,
whereby said floss in said gap may be used by a user to floss a user's teeth and may be pulled through said tubular section as desired by a user to expose any unexposed portion of said floss.

2. The device of claim 1 wherein said tubular section is comprised of a flexible material.

3. The device of claim 1 wherein said gap is approximately between 2 centimeters and 20 centimeters in length.

4. The device of claim 1 wherein the length of said loop of dental floss is approximately between 10% and 80% greater than the tubular distance.

5. The device of claim 1 further comprising means for informing a user into which direction said loop of dental floss should be pulled to expose an unexposed portion of said floss from said tubular section.

6. The device of claim 5 wherein said means for informing a user into which direction said loop of dental floss should be pulled comprises one or more directional indicia, color coding, or words representing which of said floss has been used and is old and which of said floss has not been used and is new.

7. The device of claim 1 further comprising means for detecting when said loop of dental floss has completed a complete cycle through said tubular section.

8. A flossing device comprising:
(a) a plurality of tubular sections having a leading end and a trailing end defining a tubular distance therebetween, and further having an internal channel between said leading end and said trailing end; and
(b) a loop of dental floss within said internal channel of each of said plurality of tubular sections wherein said loop of dental floss has a length greater than a combined distance defined by all of said tubular distances combined such that a portion of said loop is exposed from the leading end of one of said plurality of tubular sections and the trailing end of another one of said plurality of tubular sections thereby defining a gap,
whereby said floss in said gap may be used by a user to floss a user's teeth and the leading end of one of said plurality of tubular sections adjacent to said gap may be moved to the trailing end of another one of said plurality of tubular sections adjacent to said gap as desired by a user to expose any unexposed portion of said floss.

9. The device of claim 8 wherein said gap is approximately between 2 centimeters and 20 centimeters in length.

10. The device of claim 8 wherein said gap is approximately equal to or greater than the tubular distance of one of said plurality of tubular sections.

11. The device of claim 8 further comprising means for informing a user into which direction one of said plurality of tubular sections adjacent to said gap should be moved to expose an unexposed portion of said floss.

12. The device of claim 11 wherein said means for informing a user into which direction said one of said plurality of tubular sections should be moved comprises one or more directional indicia, color coding, or words representing which of said floss has been used and is old and which of said floss has not been used and is new.

13. The device of claim 8 further comprising means for detecting when all of said loop of dental floss has been completely exposed after movement of said plurality of tubular sections has been completed.
